(19) United States
(12) Patent Application Publication
(10) Pub. No.: US 2013/0247663 A1
(43) Pub. Date: Sep. 26, 2013

(54) Multichannel Gyroscopic Sensor

(71) Applicant: Parin Patel, San Francisco, CA (US)

(72) Inventor: Parin Patel, San Francisco, CA (US)

(21) Appl. No.: 13/430,124

(22) Filed: Mar. 26, 2012

(51) Int. Cl. G01C 19/56

(52) U.S. Cl. 73/504.12

(57) ABSTRACT

An electronic device may have a gyroscopic sensor. The gyroscopic sensor may produce angular velocity data in response to movement of the electronic device. The gyroscopic sensor may have a first and second parallel branches of circuitry that are configured to produce angular velocity data from microelectromechanical systems output signals. When performing functions such as gaming or navigation functions, the electronic device may use the first branch of circuitry to produce angular velocity data with a large dynamic range. When performing functions such as image stabilization operations, the electronic device may use the second branch of circuitry to produce angular velocity data that is characterized by a relatively small amount of noise.

### BACKGROUND

This relates generally to sensors for electronic devices and, more particularly, to gyroscopic sensors.

Electronic devices such as tablet computers and cellular telephones may have sensors. For example, accelerometers may be used to determine the orientation of a device relative to the Earth. An accelerometer may, for example, gather information on whether a display is being held upright or whether the display has been inverted. Device functions such as functions associated with controlling the orientation of images on the display may use orientation data from the accelerometer.

Another type of sensor that is sometimes used in gathering information on the orientation of an electronic device is a gyroscopic sensor. Gyroscopic sensors may contain vibrating masses. When an electronic device containing a gyroscopic sensor of this type is rotated, the vibrating mass in the gyroscopic sensor will be deflected due to Coriolis force. The resulting output of the gyroscopic sensor can be used to determine the angular velocity of the electronic device.

Angular velocity information from a gyroscopic sensor in an electronic device can be used in controlling a variety of device functions. For example, angular velocity information may be used in controlling game functions or can be used for implementing image stabilization functions for a camera system. The different types of device functions for which angular velocity information from a gyroscopic sensor can be used may place competing demands on a gyroscopic sensor. For example, game functions may require a high dynamic range, whereas image stabilization operations may require low noise. If care is not taken, a gyroscopic sensor may be unable to cover desired amounts of dynamic range without exhibiting excessive noise.

It would therefore be desirable to be able to provide electronic devices with improved gyroscopic sensors.

### SUMMARY

An electronic device may have a gyroscopic sensor. The gyroscopic sensor may produce angular velocity data in response to movement of the electronic device. Some device functions such as gaming and navigation functions may benefit from the use of angular velocity data that has a relatively high dynamic range. Other device functions such as image stabilization may benefit from the use of low noise angular velocity data.

The gyroscopic sensor may have a first and second parallel branches of circuitry that are configured to produce angular velocity data from microelectromechanical systems output signals. The microelectromechanical systems output signals may be produced by a shared microelectromechanical device or the first branch of circuitry may receive signals from a first microelectromechanical systems device while the second branch of circuitry receives signals from a second microelectromechanical systems device.

The electronic device may use the first branch of circuitry during one mode of operation and may use the second branch of circuitry during another mode of operation. For example, when performing functions such as gaming or navigation functions, the electronic device may use the first branch of circuitry in the gyroscopic sensor to produce angular velocity data with a large dynamic range. When performing functions such as image stabilization operations, the electronic device may use the second branch of circuitry in the gyroscopic sensor to produce angular velocity data that is characterized by a relatively small amount of noise and delay.

If desired, both the first and second branches of circuitry can be used simultaneously. For example, the second branch may be used for image stabilization operations while the first branch is being used to log data in the background to support a motion tracking or navigation application.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative electronic device with a gyroscopic sensor in accordance with an embodiment of the present invention.

FIG. 2 is a table showing how different functions in an electronic device may have different desired maximum values for angular velocity dynamic range and noise in accordance with an embodiment of the present invention.

FIG. 3 is a diagram of an illustrative gyroscopic sensor in accordance with an embodiment of the present invention.

FIG. 4 is a graph showing how resources in a gyroscope may exhibit a tradeoff between signal-to-noise ratio and dynamic range in accordance with an embodiment of the present invention.

FIG. 5 is a cross-sectional side view of an illustrative packaged gyroscopic sensor and additional components mounted on a printed circuit in accordance with an embodiment of the present invention.

FIG. 6 is a cross-sectional side view of an illustrative gyroscopic sensor microelectromechanical systems (MEMS) device showing how the MEMS device may have internal structures that are configured to exhibit a desired tradeoff between dynamic range and noise in accordance with an embodiment of the present invention.

FIG. 7 is a cross-sectional side view of an illustrative packaged gyroscopic sensor and additional components mounted on a printed circuit in a configuration in which the packaged gyroscopic sensor has multiple microelectromechanical systems (MEMS) devices in accordance with an embodiment of the present invention.

FIG. 8 is a flow chart of illustrative steps involved in operating an electronic device having a gyroscopic sensor in accordance with an embodiment of the present invention.

### DETAILED DESCRIPTION

An electronic device may be provided with sensors. The sensors may be used in gathering information about the status of the electronic device and its environment. For example, light-based sensors may be used in gathering information regarding ambient light levels and the proximity of external objects. Touch sensors and buttons may be used in receiving user input commands.

Many electronic device functions benefit from knowledge of the orientation of the electronic device. For example, device functions that relate to displaying images on a display may benefit from knowledge of whether the display is being held in an upright position or whether the display has been inverted. The orientation of an electronic device may be ascertained using an orientation sensor such as a three-axis accelerometer. With this type of sensor, information can be gathered that indicates the direction of the Earth's gravity relative to the device. Based on the orientation of the Earth's gravity, the orientation of the device relative to the Earth may be determined. Information on the rotational orientation of a device may be gathered using a compass.

Some device operations may rely upon information on angular device movement. For example, image stabilization functions may use information on how much a device is jiggling up and down or otherwise moving in the hands of a user to produce counteracting lens position adjustments or counteracting position adjustments for a camera module or image sensor. As another example, game functions may use information that specifies how a device is being rotated by a user (e.g., to steer a car on a virtual track, to make a golf swing in a golf game, or to perform other game control functions). Navigation functions may also benefit from information on the amount of rotation of a device.

Although angular orientation information and information on the orientation of a device relative to the Earth's gravity may be obtained from sensors such as compasses and accelerometers, it is often desirable to use additional sensors such as gyroscopic sensors to measure angular device movement. Gyroscopic sensors, which may sometimes be referred to as gyroscopes, may be able to more accurately measure angular velocity than other types of sensors and may therefore be helpful in ensuring accurate device operation. Gyroscopic sensors may, for example, produce accurate angular velocity information that can be used in producing game input, input for an image stabilization system, or other device functions (alone or in combination with data from other sensors such as accelerometers and compasses).

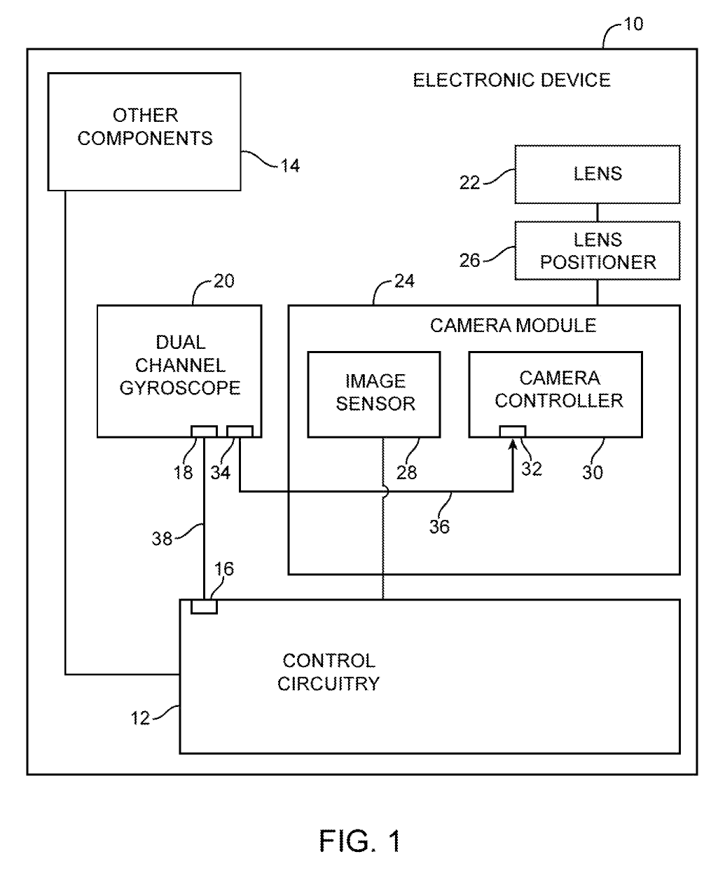

An illustrative electronic device of the type that may be provided with a gyroscopic sensor is shown in FIG. 1. Electronic device 10 may be a laptop computer, a tablet computer, a somewhat smaller portable device such as a wrist-watch device, pendant device, or other wearable or miniature device, a cellular telephone, a media player, a tablet computer, a gaming device, a navigation device, a handheld device, or other electronic equipment.

Device 10 may include control circuitry 12. Control circuitry 12 may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in control circuitry 12 and other control circuitry in device 10 may be used to control the operation of device 10. This processing circuitry may be based on one or more microprocessors, microcontrollers, digital signal processors, baseband processors, power management units, audio codec chips, application specific integrated circuits, etc.

Control circuitry 12 may be used to run software on device 10, such as internet browsing applications, voice-over-internet-protocol (VOIP) telephone call applications, email applications, media playback applications, operating system functions, game functions, navigation functions, functions related to capturing digital images and performing image stabilization operations, etc. To support interactions with external components, control circuitry 12 and other components 14 in device 10 may include communications circuitry. As an example, control circuitry 12 may include communications circuitry such as communications interface 16 for communicating with corresponding communications circuitry such as communications interface 18 in gyroscopic sensor 20 over communications path 38.

Electronic device 10 may include camera system components such as lens 22 and camera module 24 for acquiring digital images. Both still and moving digital image data (video) may be acquired using camera module 24. Lens positioner 26 may be used to adjust the position of lens 22 in real time, based on commands from control circuitry in camera module 24. Camera module 24 may include an image sensor such as image sensor 28 that captures digital images (i.e., still images and/or video) corresponding to image light that has been focused onto image sensor 28 using lens 22.

The position of lens 22 may be controlled by lens positioner 26 to implement an image stabilization scheme. If desired, image stabilization functions may be implemented using a system in which the position of lens 22 is fixed. For example, image stabilization functions may be implemented by moving image sensor 28 using a positioner such as positioner 26 or by digitally stabilizing image data (e.g., by processing the digital image data from sensor 28 using an image stabilization process that uses gyroscopic sensor data and digital image data from sensor 28 as inputs). In digital image stabilization schemes, motion vectors extracted from gyroscopic sensor data can be used to reduce the computational burden on the digital image stabilization process (e.g., by estimating camera motion).

Camera module 24 may include a camera controller such as camera controller 30 (and/or camera controller circuitry may be implemented as part of control circuitry 12). Camera controller 30 may have a communications circuit such as communications interface 32 that supports communications with a corresponding communications circuit such as communications interface 34 of gyroscopic sensor 20 over communications path 36. Camera controller 30 can gather gyroscope data from gyroscopic sensor 20 in real time via path 36. The gyroscope data may include angular velocity information such as digital angular velocity data. The angular velocity information may be used to perform image stabilization operations. For example, angular velocity information may be used by a digital image stabilization process to help digitally stabilize still and/or video image data. In a scheme in which image stabilization is performed by moving lens 22, the angular velocity information may be used by camera controller 30 to adjust the position of lens 22 to compensate for movement in electronic device 10 relative to the scene that is being captured using image sensor 28 (i.e., the angular velocity information may be used to implement an image stabilization scheme for the digital camera system formed by lens 22, lens positioner 26, and camera module 24).

In addition to camera system components, device 10 may include other components 14. Components 14 may include input-output circuitry. The input-output circuitry may be used to allow data to be supplied to device 10 and to allow data to be provided from device 10 to external devices. Input-output circuitry in device 10 may include input-output devices such as touch screens, displays without touch sensor capabilities, buttons, joysticks, click wheels, scrolling wheels, touch pads, key pads, keyboards, microphones, speakers, tone generators, vibrators, cameras, sensors, light-emitting diodes and other status indicators, data ports, etc. A user can control the operation of device 10 by supplying commands through input-output devices in components 14 and may receive status information and other output from device 10 using the output resources of input-output devices in components 14. Components 14 may also include wireless communications circuitry such as radio-frequency (RF) transceiver circuitry formed from one or more integrated circuits, power amplifier circuitry, low-noise input amplifiers, passive RF components, one or more antennas, and other circuitry for handling RF wireless signals.

Device 10 can be controlled by control circuitry such as control circuitry 12, control circuitry in camera module 24, control circuitry associated with gyroscopic sensor 20, and control circuitry associated with other components 14. The control circuitry may be configured to store and execute control code for implementing control algorithms (e.g., algorithms that use gyroscopic sensor data and other data to present gaming content, navigation content, or other content on a display in components 14, to control image stabilization functions for the camera system including camera module 24 and lens 22, and other algorithms).

Different device functions in device 10 may benefit from different types of gyroscopic sensor data. For example, some functions such as gaming functions may use angular velocity data that covers a large range of values, whereas other functions such as image stabilization functions may require low noise angular velocity data. To support both types of functions in device 10, gyroscopic sensor 20 may support multiple modes of operation, each of which is tailored to supporting a particular type of function in device 10. There is generally a tradeoff between dynamic range and noise when producing gyroscopic sensor data. By supporting multiple modes of operation, gyroscopic sensor 20 may be selectively operated to produce output signals with higher dynamic range and higher noise or to produce output signals with lower dynamic range and lower noise.

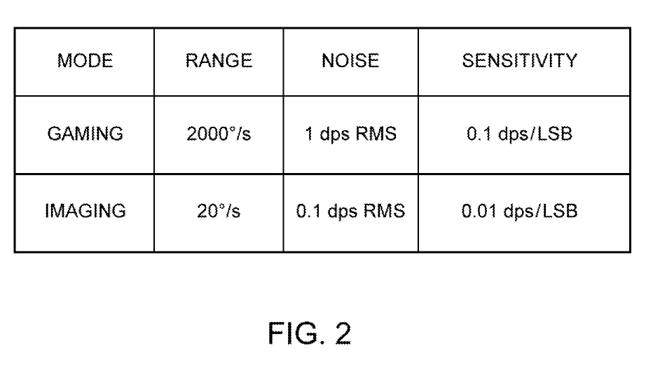

As an example, gyroscopic sensor 20 may support a first mode such as a gaming mode and a second mode such as an imaging mode, each of which is associated with angular velocity data with different characteristics. As shown in the illustrative table of FIG. 2, for example, the angular velocity data that is produced by gyroscopic sensor 20 when gyroscopic sensor 20 is operated in the gaming mode covers a wide dynamic range (e.g., 0-2000°/s) and is associated with a relatively large amount of noise such as 1 degree per second (dps) RMS (root mean square). The angular velocity data that is produced by gyroscopic sensor 20 when gyroscopic sensor 20 is operated in the imaging mode covers a narrow dynamic range (e.g., 0-20°/s) and is associated with a relatively small amount of noise (0.1 dps RMS). Other sensor characteristics such as sensitivity may also vary when sensor 20 is operated in different modes. In the example of FIG. 2, gyroscopic sensor 20 supports two different modes of operation. This is merely illustrative. In general, gyroscopic sensor 20 may support any suitable number of operating modes (e.g., two or more, three or more, etc.).

When operated in the high-dynamic-range mode (i.e., gaming mode), a user may manipulate device 10 so that device 10 exhibits relatively large amounts of angular velocity. Gyroscopic sensor 20 may produce angular velocity readings with a correspondingly large dynamic range at its output. Because gyroscopic sensor 20 is characterized by a large dynamic range when operated in the high-dynamic-range mode, large angular velocities will not saturate sensor 20, even when a user makes abrupt motions (e.g., when moving device 10 to mimic a golf swing, when tilting device 10 back and forth in a balance-type game, when rotating device 10 rapidly as part of a navigation operation or other non-game operation).

When operated in the low-dynamic-range mode, (i.e., imaging mode), a user may hold device 10 steady to take a picture of a scene using the camera in device 10. Although attempting to hold device 10 steady, device 10 will inevitably exhibit minor changes in position when held in the user's hands. Because these changes in position are minor, the angular velocity data that is produced by gyroscopic sensor will tend to be small (e.g., less than 20°/s in magnitude). Gyroscopic sensor 20 will therefore generally not exceed its modest dynamic range capabilities. Because gyroscopic sensor 20 is characterized by a small dynamic range when operated in the low-dynamic-range mode, gyroscopic sensor 20 will be able to produce an output signal with lower noise (e.g., 0.1 dps RMS in the example of FIG. 2). These low noise output signals may be helpful in improving image stabilization performance (i.e., by making the position corrections that are imposed on lens 22 by lens positioner 26 more accurate than would otherwise be possible or by making motion estimations that are used as inputs to a digital image stabilization process more accurate than would otherwise be possible).

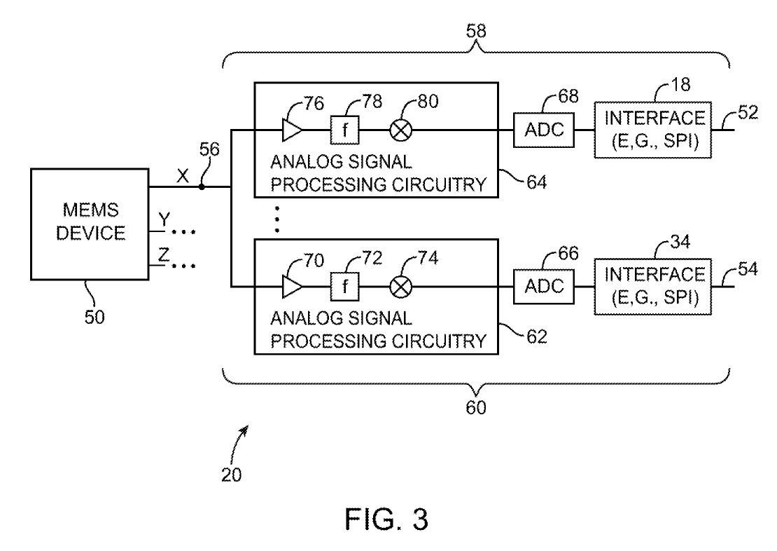

A circuit diagram of an illustrative configuration that may be used to implement a dual mode (dual channel) gyroscopic sensor is shown in FIG. 3. In the example of FIG. 3, gyroscopic sensor 20 has been implemented using a vibrating mass sensor configuration. Other types of gyroscopic sensor may be used if desired.

Micromechanical systems (MEMS) device 50 contains a vibrating mass. When an electronic device containing a gyroscopic sensor device of this type is rotated, the vibrating mass will be deflected due to Coriolis force, resulting in raw angular velocity data (e.g., capacitance data) on outputs X, Y, and Z (corresponding to the three orthogonal dimensions X, Y, and Z). Each output of MEMS device 50 may have a different corresponding set of processing circuits. In the example of FIG. 3, the circuitry associated with the “X” output of MEMS device 50 is shown in detail.

The circuitry of FIG. 3 may be used to covert raw output data from MEMS device 50 into digital gyroscope output data on outputs such as outputs 52 and 54. Each output of MEMS device 50 may have multiple parallel processing circuit branches (channels). For example, output X of device 50, which is coupled to node 56, may have parallel first and second circuit branches such as branch 58 and branch 60. The circuitry of branch 58 may be used to produce angular velocity data in a first mode of operation for sensor 20, whereas the circuitry of branch 60 may be used to produce angular velocity data in a second mode of operation for sensor 20. Additional parallel branches may be provided to support additional modes of operation if desired. The use of two parallel branches for each output X, Y, and Z (i.e., a dual-mode sensor configuration) is sometimes described herein as an example.

As shown in FIG. 3, each branch (channel) of gyroscopic sensor 20 may have a corresponding output. For example, branch 58 may process signals on node 56 to produce digital angular velocity data on output 52, whereas branch 60 may process the signals on node 56 to produce digital angular velocity data on output 54. Outputs 52 and 54 may be coupled to control circuitry in device 10 that uses gyroscope data. For example, output 52 may be coupled to path 38 of FIG. 1 and output 54 may be coupled to path 36 of FIG. 1.

Each branch in sensor 20 may have a corresponding set of circuit components. For example, branch 58 may have analog signal processing circuitry 64, analog-to-digital converter 68, and communications interface 18, whereas branch 60 may have analog signal processing circuitry 62, analog-to-digital converter circuitry 66, and communications interface 34.

In branch 58, analog signal processing circuitry 64 may include a capacitance-to-voltage conversion circuit such as circuit 76 that converts capacitance variations on node 56 into an output voltage. Filter circuitry 78 may be used to reduce noise in the output voltage from circuit 76. Demodulation circuitry 80 may remove the carrier (drive) frequency associated with the moving mass from the voltage at the output of filter circuitry 78. Analog-to-digital converter 68 may convert the voltage at the output of demodulation circuitry 80 to a corresponding digital value that represents the angular velocity measured for the X output of device 50. Interface 18 may be used to transmit the digital angular velocity data from analog-to-digital converter 68 to a corresponding communications interface (see, e.g., communications interface 16 of FIG. 1).

The circuitry of branch 60 is similar to that of branch 58, but is configured to exhibit different dynamic range and noise characteristics. As shown in FIG. 3, branch 60 may have analog signal processing circuitry 62 that includes a capacitance-to-voltage conversion circuit such as circuit 70 to convert capacitance variations on node 56 into an output voltage. Filter circuitry 72 may be used to reduce noise in the output voltage from circuit 70. Demodulation circuitry 74 may remove the carrier frequency associated with the moving mass in device 50 from the voltage at the output of filter circuitry 72. Analog-to-digital converter 66 can then convert the voltage at the output of demodulation circuitry 74 (i.e., the output of analog signal processing circuitry 62) to a corresponding digital value that represents the angular velocity measured for the X output of device 50. Interface 34 may be used to transmit the digital angular velocity data from analog-to-digital converter 66 in branch 60 to a corresponding communications interface (see, e.g., communications interface 32 of FIG. 1).

Communications interfaces 18 and 34 may be used to covey digital data using any suitable communications protocols. Communications interfaces may be characterized by different bandwidths, different latencies, and other operating characteristics and may be selected by appropriately matching these characteristics to each branch. With one suitable arrangement, communications interface 18 may be a Serial Peripheral Interface (SPI) or other interface that supports synchronous serial data and communications interface 34 may be an I²C (Inter-Integrated Circuit) interface or other serial single-ended bus.

Each of the circuits in branches 58 and 60 may be configured to exhibit a different tradeoff between dynamic range and signal-to-noise ratio, so that branches 58 and 60 exhibit different tradeoffs between dynamic range and noise level. When a first dynamic range and first noise level are desired (e.g., lower dynamic range and lower noise), angular velocity data may be gathered from branch 58. When a second dynamic range and second noise level are desired (e.g., higher dynamic range and higher noise), angular velocity information may be gathered from branch 60.

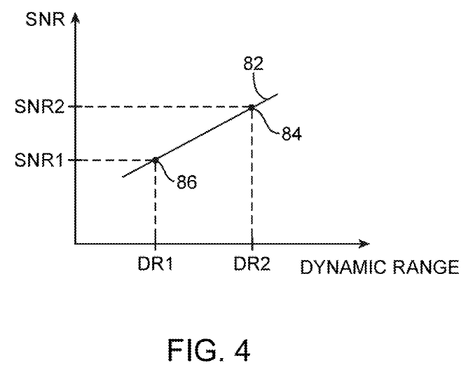

The graph of FIG. 4 shows how each circuit in gyroscopic sensor 20 may be configured to trade off dynamic range and signal-to-noise ratio (SNR). Curve 82 of FIG. 4 is representative to the type of tradeoff associated with designing components such as capacitance-to-voltage circuits 76 and 70, filter circuitry 78 and 72, demodulation circuitry 80 and 74, and analog-to-digital converters 68 and 66. When forming a circuit branch (e.g., branch 60) that is to handle high dynamic range angular velocity data at the expense of somewhat higher SNR levels, one or more components in that branch can be configured to exhibit the characteristics associated with point 84 of curve 82 (e.g., higher dynamic range DR2 and higher signal-to-noise ratio SNR2). When forming a circuit branch (e.g., branch 58) that is to produce angular velocity that exhibits a relatively smaller signal-to-noise ratio at the expense of reduced dynamic range, one or more components in that branch can be configured to exhibit the characteristics associated with point 86 on curve 82 (e.g., lower dynamic range DR1 and lower signal-to-noise radio SNR1).

By implementing one or more of the individual circuits in each branch appropriately according to the relationship plotted in FIG. 4, the overall performance of each circuit branch can be tailored to its intended function. During operation of device 10, device 10 can switch between use of the different branches to support different functions. For example, when performing gaming or navigation functions, branch 60 may be used to provide high-dynamic-range angular velocity data to a game application, navigation software, or other resources that benefit from high-dynamic-range data and when performing image stabilization functions, branch 58 may be used to provide low-noise angular velocity data to image stabilization software or other resources that benefit from low-signal-to-noise data. Each of the outputs in MEMS device 50 may be use the same type of branch (e.g., high-dynamic range or low noise) in parallel (i.e., a first branch such as branch 58 may be used to handle data from output X while identical (or at least similar) branches 58 are used to handle data from outputs Y and Z, etc.).

Device 10 may, if desired, use branches 58 and 60 simultaneously. For example, branch 58 may be used for image stabilization operations while branch 60 is being used to log data in the background to support a motion tracking or navigation application. Device 10 may toggle between use of one of the branches in a first mode of operation and simultaneous use of both branches in a second mode of operation or may support three or more distinct operating modes (e.g., a first mode of operation in which branch 58 is active, a second mode of operation in which branch 60 is active, and a third mode of operation in which branches 58 and 60 are simultaneously active). Other combinations of operating modes may be used if desired.

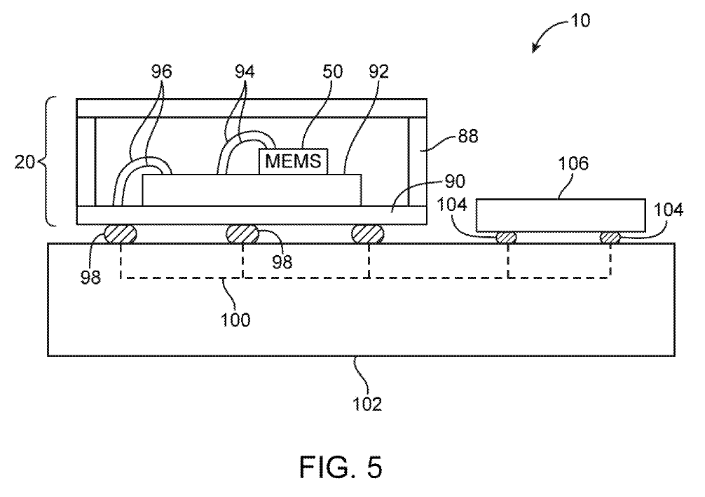

FIG. 5 is a cross-sectional side view of a portion of device 10 showing how dual channel gyroscopic sensor 20 may be mounted on a substrate and interconnected with other device components. As shown in FIG. 5, gyroscopic sensor 20 may contain MEMS device 50 (FIG. 3) and application-specific integrated circuit 92 (e.g., a gyroscopic sensor signal processing circuit that includes the processing circuitry of branches 58 and 60 of FIG. 3). Wire bonds 94 or other conductive paths may be used to interconnect MEMS device 50 to integrated circuit 92. Wire bonds 96 or other conductive paths may be used to connect integrated circuit 92 to substrate portion 90 of gyroscopic sensor package 88.

Package 88 may be mounted to traces 100 of printed circuit 102 via solder connections 98. Printed circuit 102 may be a rigid printed circuit board (e.g., an FR4 board) or may be a flexible printed circuit (“flex circuit”) formed from a flexible sheet of polyimide or other polymer. Solder connections 104 may be used to interconnect traces 100 to component(s) 106. Components 106 may be used to implement control circuitry 12, camera system components, and other components 14 (see, e.g., FIG. 1). Traces 100 may include paths such as paths 38 and 36 of FIG. 1. Integrated circuit 92 may include circuitry for implementing communications interfaces such as communications interfaces 18 and 34. Circuitry in component(s) 106 may include circuitry for image sensor 28, camera controller 30 and communications interface 32, control circuitry 12 and communications interface 16, and other circuitry for supporting the operation of device.

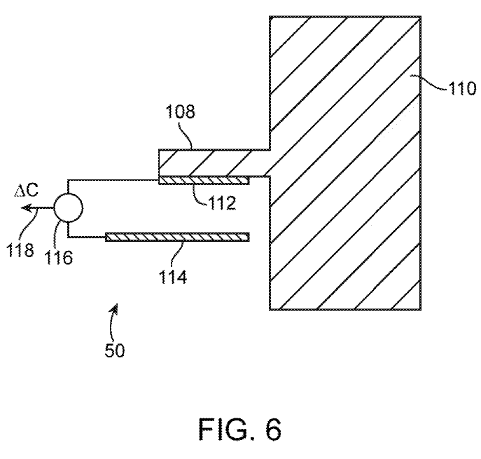

If desired, gyroscopic sensor 20 may include multiple MEMS devices such as MEMS device 50 of FIG. 5. As shown schematically in FIG. 6, each MEMS device may include a vibrating mass such as vibrating cantilever 108 on support structure 110. Capacitor electrodes such as electrodes 112 and 114 may exhibit a capacitance C that varies in proportion to the movement of mass 108. Capacitance sensor 116 may be used to produce an output signal on output 118 (e.g., a change in capacitance signal) by measuring capacitance C in real time. In a gyroscopic sensor 20 that has multiple MEMS devices (e.g., multiple vibrating mass gyroscope devices), each device can be constructed with a different set of attributes so as to produce output with appropriately tailored tradeoff between dynamic range and noise attributes.

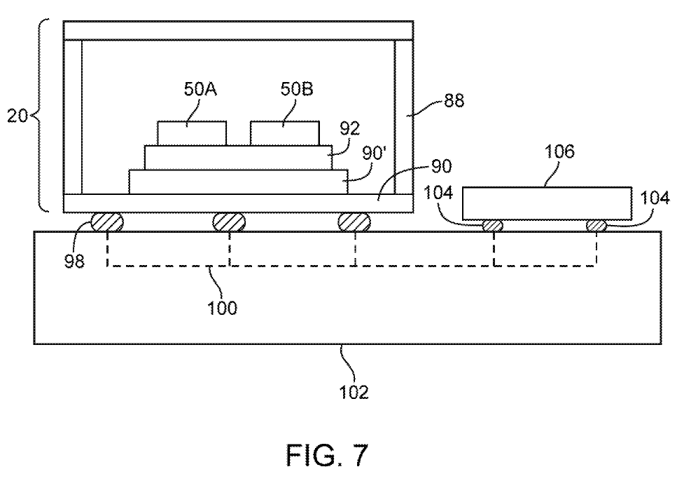

As shown in FIG. 7, for example, gyroscopic sensor 20 may have a first MEMS device such as MEMS device 50A and a second MEMS device such as MEMS device 50B. If desired, MEMS device 50A may be configured to produce a higher dynamic range (and higher noise) output than MEMS device 50B. During operation, signals from MEMS device 50A may be processed using an appropriate (e.g., high dynamic range) branch of processing circuitry such as circuit branch 60 of FIG. 3, whereas signals from MEMS device 50B may be processed using an appropriate (e.g., low noise) branch of processing circuitry such as circuit branch 58 of FIG. 3. The circuitry of branches 58 and 60 may be implemented in one or more integrated circuits such as application-specific integrated circuit 92 (i.e., a gyroscopic sensor signal processing circuit).

Wire bonds or solder balls may be used in interconnecting MEMS devices 50A and 50B with integrated circuit 92 and traces on a substrate such as substrate 90′. Substrate 90′ may be a rigid or flexible printed circuit board and may be used in routing signals to traces 100 on substrate 102 via solder connections 98 with or without using conductive paths in substrate portion 90 of package 88. Traces 100 may be coupled to one or more additional components 106 mounted on substrate 102 using solder 104.

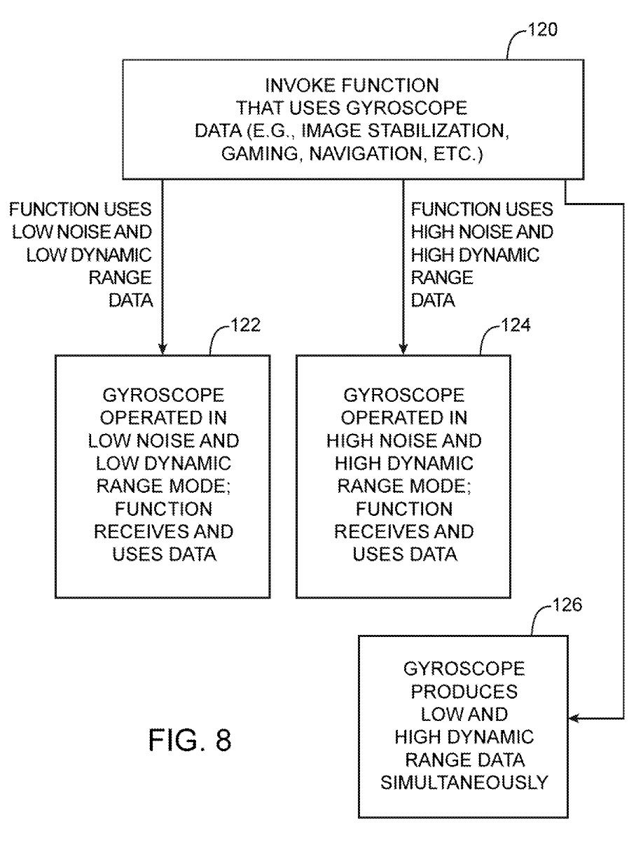

A flow chart of illustrative steps involved in operating a device such as device 10 of FIG. 1 that has a multimode gyroscopic sensor such as gyroscopic sensor 20 is shown in FIG. 8.

At step 120, device 10 may invoke a function that involves the use of gyroscopic sensor data. The function that is invoked may be a gaming function, a navigation function, a mapping function, a camera function such as an image stabilization function, another function that involves the use of gyroscopic sensor data, or a combination of such functions. The function may use a single type of data (low or high dynamic range data) or may use multiple types of data (e.g., both low and high dynamic range data). The function that is invoked may be invoked manually (e.g., in response to user input) or automatically (e.g., in response to satisfaction of timing criteria, location-based criteria, or other criteria). The invoked function may be implemented using an application and/or an operating system running on control circuitry 12 of FIG. 1.

If the invoked function is of the type that benefits from low noise angular velocity data and can use angular velocity data with a small dynamic range, device 10 may, at step 122, gather low noise and low dynamic range (and low delay) gyroscopic sensor data from gyroscopic sensor 20. An digital image stabilization function or an image stabilization function that involves motion of lens 22 and that is being implemented using control circuitry such as camera controller 30 of FIG. 1 may, for example, use communications interface 32 to obtain low noise and low dynamic range gyroscopic sensor data from branch 58 of gyroscopic sensor 20 over a path such as path 36 of FIG. 1 (e.g., from communications interface 34 of gyroscopic sensor 20).

If the invoked function is of the type that benefits from high dynamic range angular velocity data and can use angular velocity data with a higher amount of noise, device 10 may, at step 124, gather higher noise and lower dynamic range gyroscopic sensor data from gyroscopic sensor 20. A gaming or navigation function being implemented using control circuitry such as control circuitry 12 of FIG. 1 may, for example, use communications interface 16 to obtain higher dynamic range and higher noise gyroscopic sensor data from branch 60 of gyroscopic sensor 20 over a path such as path 38 of FIG. 1 (e.g., from communications interface 18 of gyroscopic sensor 20).

If the invoked function is of the type that benefits from both (1) low noise and low dynamic range angular velocity data and (2) high noise and high dynamic range angular velocity data, device 10 may, at step 126 simultaneously use branches 58 and 60 to gather data from gyroscopic sensor 20. A gaming or navigation function being implemented using control circuitry such as control circuitry 12 of FIG. 1 may, for example obtain higher dynamic range and higher noise gyroscopic sensor data from branch 60 of gyroscopic sensor 20 while control circuitry 12, camera module 24, or other circuitry in device 10 simultaneously obtains low noise and low dynamic range gyroscopic sensor data from branch 58 of gyroscopic sensor 20.

In sensor configurations of the type shown in FIG. 5, each circuit branch (e.g., branch 58 and branch 60) may obtain MEMS output data from the same MEMS device 50. In sensor configurations of the type shown in FIG. 7, each circuit branch (e.g., branch 58 and branch 60) may obtain MEMS output data from a respective one of MEMS devices such as devices 50A and 50B.

The foregoing is merely illustrative of the principles of this invention and various modifications can be made by those skilled in the art without departing from the scope and spirit of the invention.

What is claimed is:

1. An electronic device, comprising:
a gyroscopic sensor; and
control circuitry, wherein the gyroscopic sensor and control circuitry are configured to operate in a first mode in which the control circuitry receives gyroscopic data from the gyroscopic sensor that is characterized by a first amount of dynamic range and a first amount of noise and a second mode in which the control circuitry receives gyroscopic data from the gyroscopic sensor that is characterized by a second amount of dynamic range and a second amount of noise, wherein the first amount of dynamic range is larger than the second amount of dynamic range, and wherein the first amount of noise is greater than the second amount of noise.

2. The electronic device defined in claim 1 wherein the gyroscopic sensor comprises:
a microelectromechanical systems device that produces at least one output signal;
a first branch of circuitry that processes the at least one output signal to produce the gyroscopic data that is characterized by the first amount of dynamic range and the first amount of noise; and
a second branch of circuitry that processes the at least one output signal to produce the gyroscopic data that is characterized by the second amount of dynamic range and the second amount of noise.

3. The electronic device defined in claim 2 wherein the first branch of circuitry includes a first analog signal processing circuit and a first analog-to-digital converter to process the at least one output signal to produce the gyroscopic data that is characterized by the first amount of dynamic range and the first amount of noise and wherein the second branch of circuitry includes a second analog signal processing circuit and a second analog-to-digital converter to process the at least one output signal to produce the gyroscopic data that is characterized by the second amount of dynamic range and the second amount of noise.

4. The electronic device defined in claim 3 wherein:
the first branch comprises a first communications interface with which the gyroscopic data that is characterized by the first amount of dynamic range and the first amount of noise is communicated to a second communications interface; and
the second branch comprises a third communications interface with which the gyroscopic data that is characterized by the second amount of dynamic range and the second amount of noise is communicated to a fourth communications interface.

5. The electronic device defined in claim 4 wherein the first communications interface comprises a serial single-ended bus.

6. The electronic device defined in claim 5 wherein the third communications interface comprises an interface that supports synchronous serial data.

7. The electronic device defined in claim 6 further comprising a camera controller that receives the gyroscopic data using the fourth communications interface.

8. The electronic device defined in claim 3 wherein the control circuitry is configured to use the gyroscopic data that is characterized by the second amount of dynamic range and the second amount of noise in performing digital image stabilization.

9. The electronic device defined in claim 3 further comprising:
a lens; and
a lens positioner that positions the lens, wherein the control circuitry is configured to use the gyroscopic data that is characterized by the second amount of dynamic range and the second amount of noise in controlling the lens positioner to perform image stabilization.

10. The electronic device defined in claim 9 wherein the control circuitry is configured to use the gyroscopic data that is characterized by the first amount of dynamic range and the first amount of noise to implement at least one function selected from the group consisting of: a gaming function and a navigation function.

11. The electronic device defined in claim 1 wherein the gyroscopic sensor comprises:
a first microelectromechanical systems device that produces at least a first output signal;
a first branch of circuitry that processes the first output signal to produce the gyroscopic data that is characterized by the first amount of dynamic range and the first amount of noise;
a second microelectromechanical systems device that produces at least a second output signal; and
a second branch of circuitry that processes the second output signal to produce the gyroscopic data that is characterized by the second amount of dynamic range and the second amount of noise.

12. The electronic device defined in claim 11 wherein the first branch of circuitry includes a first analog signal processing circuit and a first analog-to-digital converter to process the first output signal to produce the gyroscopic data that is characterized by the first amount of dynamic range and the first amount of noise and wherein the second branch of circuitry includes a second analog signal processing circuit and a second analog-to-digital converter to process the second output signal to produce the gyroscopic data that is characterized by the second amount of dynamic range and the second amount of noise.

13. The electronic device defined in claim 11 wherein the first branch comprises a first communications interface with which the gyroscopic data that is characterized by the first amount of dynamic range and the first amount of noise is communicated to a second communications interface, wherein the second branch comprises a third communications interface with which the gyroscopic data that is characterized by the second amount of dynamic range and the second amount of noise is communicated to a fourth communications interface, and wherein the control circuitry is configured to use the gyroscopic data that is characterized by the second amount of dynamic range and the second amount of noise in performing digital image stabilization.

14. The electronic device defined in claim 11 wherein the first branch comprises a first communications interface with which the gyroscopic data that is characterized by the first amount of dynamic range and the first amount of noise is communicated to a second communications interface, wherein the second branch comprises a third communications interface with which the gyroscopic data that is characterized by the second amount of dynamic range and the second amount of noise is communicated to a fourth communications interface, and wherein the electronic device further comprises:
a lens; and
a lens positioner that positions the lens, wherein the control circuitry is configured to use the gyroscopic data that is characterized by the second amount of dynamic range and the second amount of noise in controlling the lens positioner to perform image stabilization.

15. The electronic device defined in claim 14 wherein the first communications interface comprises a serial single-ended bus.

16. The electronic device defined in claim 15 wherein the third communications interface comprises an interface that supports synchronous serial data.

17. The electronic device defined in claim 1 wherein the control circuitry is configured to receive gyroscopic data from the gyroscopic sensor that is characterized by the first amount of dynamic range and the first amount of noise during the second mode while simultaneously receiving the gyroscopic data from the gyroscopic sensor that is characterized by the second amount of dynamic range and the second amount of noise.

18. A method of operating an electronic device having control circuitry and having a gyroscopic sensor, comprising:
with the control circuitry, receiving gyroscopic data that is characterized by a first amount of dynamic range and a first amount of noise when operating in a first mode of operation; and
with the control circuitry, receiving gyroscopic data that is characterized by a second amount of dynamic range and a second amount of noise when operating in a second mode of operation, wherein the first amount of dynamic range is larger than the second amount of dynamic range, and wherein the first amount of noise is greater than the second amount of noise.

19. The method defined in claim 18 wherein the electronic device has a lens and a lens positioner, the method further comprising positioning the lens with the lens positioner using the gyroscopic data that is characterized by the second amount of dynamic range and the second amount of noise.

20. The method defined in claim 19 further comprising:
with the control circuitry, using the gyroscopic data that is characterized by the first amount of dynamic range and the first amount of noise to implement at least one function selected from the group consisting of: a gaming function and a navigation function.

21. The method defined in claim 18 wherein the gyroscopic sensor includes a first microelectromechanical systems device that produces at least a first output signal and a second microelectromechanical systems device that produces at least a second output signal, the method comprising:
using a first branch of circuitry to process the first output signal to produce the gyroscopic data that is characterized by the first amount of dynamic range and the first amount of noise; and
using the second branch of circuitry to process the second output signal to produce the gyroscopic data that is characterized by the second amount of dynamic range and the second amount of noise.

22. A gyroscopic sensor comprising:
a first branch of circuitry that produces angular velocity data that is characterized by a first amount of dynamic range and a first amount of noise;
a second branch of circuitry that produces angular velocity data that is characterized by the second amount of dynamic range and the second amount of noise, wherein the first amount of dynamic range is greater than the second amount of dynamic range and wherein the first amount of noise is greater than the second amount of noise.

23. The gyroscopic sensor defined in claim 22 further comprising:
a first microelectromechanical systems device that produces at least a first output signal that is processed by the first branch of circuitry;
a second microelectromechanical systems device that produces at least a second output signal that is processed by the second branch of circuitry;
a package in which at least the first and second microelectronic systems devices are mounted; and
circuitry mounted within the package that includes the first and second branches of circuitry.
